(19) United States
(12) Patent Application Publication
(10) Pub. No.: US 2007/0249478 A1
(43) Pub. Date: Oct. 25, 2007

(54) Rotor for a centrifuge

(76) Inventor: H. Gerald Young, South Plainfield, NJ (US)

Correspondence Address: PLEVY, HOWARD & DARCY, P.C., P.O. BOX 226, Fort Washington, PA, 19034, US

(21) Appl. No.: 11/732,133

(22) Filed: Apr. 2, 2007

Related U.S. Application Data
(60) Provisional application No. 60/788,824, filed on Apr. 3, 2006.

(51) Int. Cl. B04B 5/00; B04B 9/14

(52) U.S. Cl. 494/16

(57) ABSTRACT

A rotor for a centrifuge includes a chamber to one side of a mount, a receptacle disposed outward from and in communication with the chamber, and a movable counterweight to an opposite side of the mount.

### RELATED APPLICATIONS

The present application claims the benefit of U.S. Provisional Patent Application No. 60/788,824, filed Apr. 3, 2006, which application is hereby incorporated by reference herein in its entirety.

### FIELD OF THE INVENTION

The present invention relates to centrifuges and particularly to rotors for centrifuges.

### BACKGROUND OF THE INVENTION

It has recently been proposed that hearing aids be cleaned by spinning in a centrifuge. Prior art tabletop centrifuges used for laboratory applications have been proposed for this application. Rotors for such centrifuges generally feature a number of slots adapted to receive test tubes. It is typical for such slots to be placed on opposite sides of a mount, so that a user may balance a rotor by placing the same number of test tubes on each side of the mount during operation.

### SUMMARY OF THE INVENTION

A rotor for a centrifuge includes a chamber to one side of a mount, a receptacle disposed outward from and in communication with the chamber, and a movable counterweight to an opposite side of the mount.

A rotor for a centrifuge includes a floor portion; an end wall at a first end of the rotor and extending upward from the floor portion, the end wall having an opening defined therein; a receptacle having a continuous receptacle wall and an opening defined in the receptacle wall and coupled to the opening in the end wall; and a movable counterweight opposite from said end wall.

A method of centrifuging an object having an opening includes the steps of placing the object on a floor portion of a chamber of a rotor with the opening of the object oriented toward a receptacle in communication with the chamber; positioning a movable counterweight located to an opposite side of a mount from the chamber so as to provide a balance to the object; placing the rotor on a shaft of a centrifuge; activating the centrifuge; stopping the centrifuge, and removing the object.

### BRIEF DESCRIPTION OF THE DRAWINGS

Understanding of the present invention will be facilitated by considering the following detailed description of the preferred embodiments of the present invention taken in conjunction with the accompanying drawings, in which like numerals refer to like parts, and:

FIG. 1 is a perspective view of a rotor in accordance with an embodiment of the invention.

FIG. 2 is a top view of the rotor of FIG. 1;

FIG. 3 is a partial sectional view of the rotor of FIG. 1, showing the mount;

FIG. 4 is a perspective view, from a different angle of the view of FIG. 1, of the rotor of FIG. 1;

FIG. 5 is a side view of the rotor of FIG. 1 in an exemplary centrifuge; and

FIG. 6 is a perspective view of the rotor of FIG. 1 in an exemplary centrifuge.

FIG. 7 is a top view of a rotor in accordance with an embodiment lacking a foam block.

### DETAILED DESCRIPTION OF THE PREFERRED EMBODIMENTS OF THE INVENTION

It is to be understood that the figures and descriptions of the present invention have been simplified to illustrate elements that are relevant for a clear understanding of the present invention, while eliminating, for the purpose of clarity, many other elements found in typical rotors and centrifuges. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

Further, it should be understood that the several views of the rotor and centrifuge shown in the figures may include many decorative or ornamental features, aspects of which the particulars may be changed while maintaining the device's utility and without departing from the scope and spirit of the present invention.

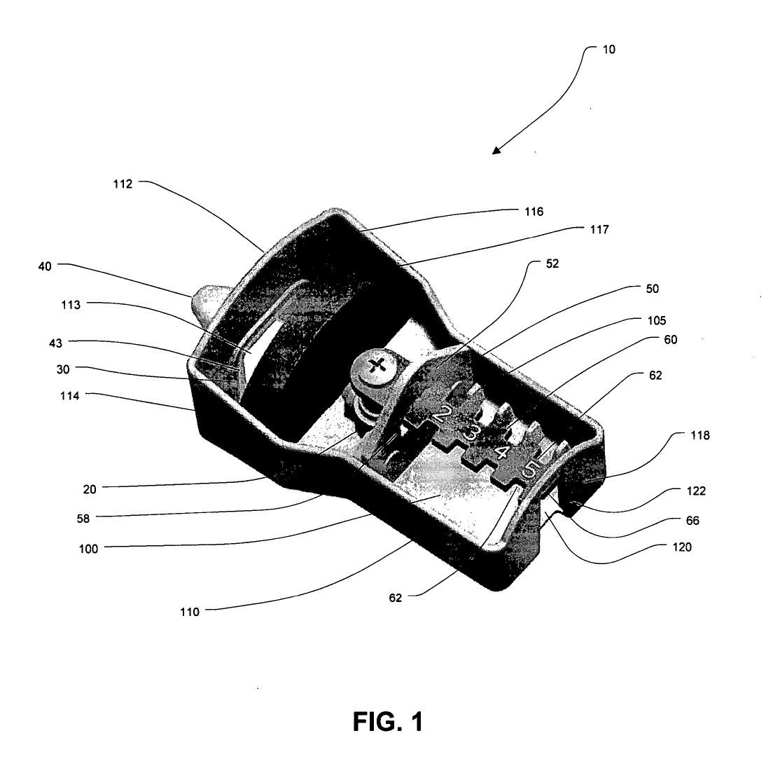

Referring to FIG. 1, a rotor 10 in accordance with an embodiment of the invention is shown. Rotor 10 is adapted to be mounted on a centrifuge, such as a centrifuge for placement on a table top or laboratory bench. In the embodiment of FIG. 1, rotor 10 is adapted to be mounted on a centrifuge by being provided with a vertical bore for receiving and engaging a rotating shaft of a centrifuge. This bore and related structure will be referred to herein as a “mount.” The location of the mount is shown at 20. Rotor 10 generally has to a first side of mount 20 a chamber 30. Receptacle 40 is disposed outward from and in communication with chamber 30. Movable counterweight 50 is disposed to a second side of mount 20 generally opposite to chamber 30 on an axis through mount 20.

Rotor 10 also generally has a planar or substantially planar and horizontal floor 100 and a planar or substantially planar, and vertical or substantially vertical, wall 110 disposed circumferentially around planar floor 100. Floor 100 is solid and generally continuous in the illustrated embodiment, but may be discontinuous or have openings therein, for example. Wall 110 is also solid and generally continuous in the illustrated embodiment, with openings in the end portions thereof, but may be discontinuous or have additional openings therein, for example. Floor 100 and wall 110 may be formed from a single molded plastic piece, of ABS, by way of example.

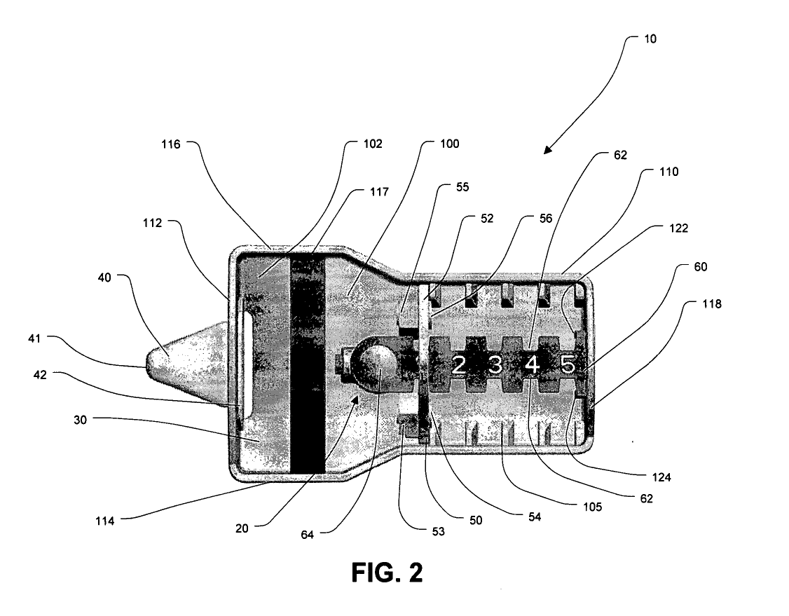

Chamber 30 is defined by generally vertical end portion 112 of wall 110, generally vertical side portions 114, 116 of wall 110, and a portion 102 (seen in FIG. 2) of floor 100. End portion 112 of wall 110 is the highest portion of wall 110, and vertical side portions 114, 116 are higher adjacent chamber 30 than elsewhere. Foam block 117 may provide an opposite end of chamber 30. Chamber 30 is in communication with receptacle 40 through opening 113 in end portion 112 of wall 110. Chamber 30 is adapted to receive an object which may benefit from the application of a centrifuge. Chamber 30 is in particular adapted to receive an object having a body with a projection extending therefrom near a central section of the body. By way of example, many models of hearing aids have such a structure. By way of example, in hearing aids of the type generally designated as “in the canal,” the portion that fits into the canal constitutes such a projection. Floor portion 102 supports an object such as a hearing aid received in chamber 30. Side portions 114, 116 restrain an object such as a hearing aid received in chamber 30 from moving laterally. End portion 112 restrains an object received in chamber 30 from moving outward away from mount 20. Opening 113 may receive an extended portion or projection of an object and serve to orient the object properly.

Receptacle 40 is adapted to receive materials expelled from an object received in chamber 30 during operation of the centrifuge. For example, if a hearing aid is the object, materials such as ear wax may be expelled from the object. As receptacle 40 is positioned outward of chamber 30 on an axis through mount 20, materials expelled from an object in chamber 30 will be expelled outward and thus into receptacle 40. Receptacle 40 is thus preferably a continuous structure adapted to prevent flow of materials therethrough. Receptacle 40 may be transparent, translucent or opaque. Receptacle 40 has an opening 42 at the inner end thereof and tapers gradually to a point at its outer end near 41. Receptacle 40 is mounted on chamber 30, and in particular is mounted on chamber 30 so as to fully close opening 113. Receptacle 40 is mounted on chamber 30 so as to remain in position when rotor 10 is being rotated during the operation of a centrifuge. Opening 42 may have a circumferential lip 43 therearound which retains receptacle 40 in place in opening 113.

Movable counterweight 50 includes plate 52 having weighted elements thereon. In the embodiment illustrated in FIG. 1, the weighted elements are first screw 53 with first nut 54 therethrough, and second screw 55 with second nut 56 therethrough. Screws 53, 55 may be self-clinching studs, by way of example. Self-clinching studs have a thin head, as the head need not receive a driver, as can be seen in FIG. 1. Self-clinching studs, or other fasteners with thin heads or no heads, are advantageous when compared with screws having heads sufficiently thick to receive and engage screwdrivers, as plate 52 may be moved closer to end wall 118 when a relatively heavy object is being counterbalanced, and the center of mass of movable counterweight 50 is closer to mount 20 when a relatively light object is being counterbalanced. Nuts 54, 56 are illustrated as hex nuts, but such illustration is merely exemplary. Movable counterweight 50 may be positioned at one of a number of positions. In the illustrated embodiment, there are five such positions. Positioning arm 60 extends from mount 20 to end portion 118 of wall 100. Positioning arm 60 is a generally planar, extended arm, with five pairs of opposing notches 62 defined in opposite sides thereof to define five positions for movable counterweight 50. Plate 52 has a generally inverted T-shaped opening 58 defined therein and therethrough. An upper portion of opening 58 is relatively narrow, and is so positioned that the upper portion fits over a notched portion of arm 60 when plate 52 is resting on floor 100, but plate 52 does not move past a full width portion of arm 60 when plate 52 is resting on floor 100. A lower portion of opening 58 is sufficiently wide to permit a full width portion of arm 60 to pass therethrough. Thus, when plate 52 is lifted upward, plate 52 may be moved along arm 60 past one or more full width portions to a selected pair of notches 62. Each pair of notches 62 may be associated with distinguishing indicia 64, such as the numerals 1, 2, 3, 4, and 5. A user may refer to a printed or electronic table which associates either weights of objects or particular models of objects (such as hearing aids) with particular ones of the indicia 64.

Floor 100 has defined therein upstanding teeth 105 at locations corresponding to notches 62 so that plate 52 is restrained at its lower edge.

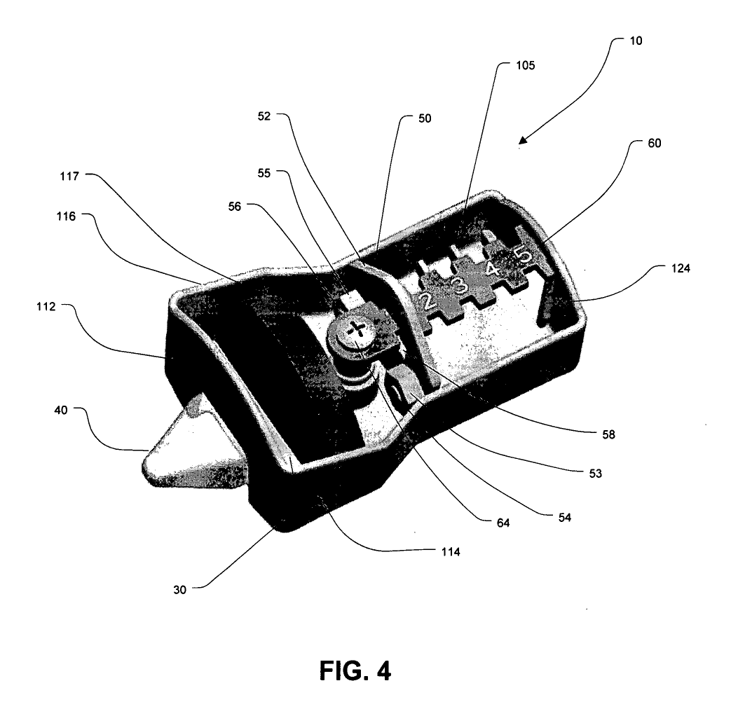

Arm 60 is fastened at one end to mount 20 by fastener 64. At an opposite end arm 60 is positioned on end wall 118. End wall 118 has opening 120 therein. On each side of end wall 118 vertical ledges 122 (best seen in FIG. 1) and 124 (best seen in FIG. 4) protrude toward mount 20 and each provide a surface on which sides of arm 60 may rest. Arm 60 has narrowed end extension 66 (best seen in FIG. 1) which fits at least partially through end wall opening 120. The vertical height between the top of end wall opening 120 and ledges 122, 124 is about or slightly more than the height of end extension 66. The width of end wall opening 120 at the top thereof is about or slightly greater than the width of end extension 66, so that end extension 66 is held in position by end wall opening 120 and ledges 122, 124.

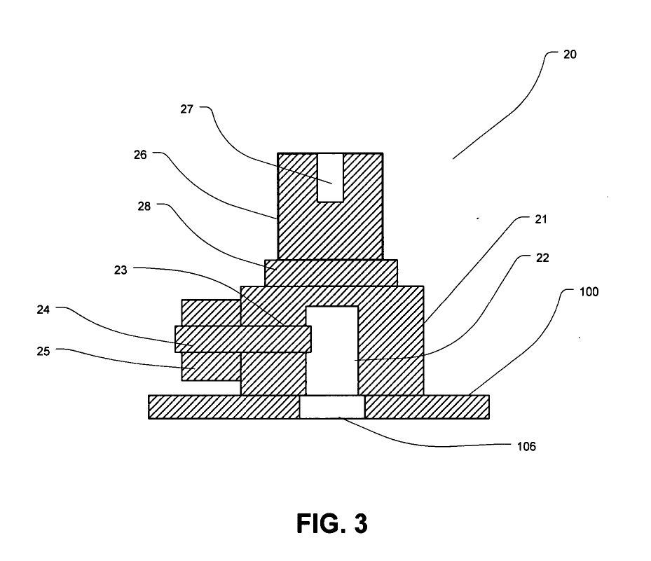

Mount 20 will now be explained in greater detail with reference to FIG. 3, which is a cross-section through mount 20 and a portion of floor 100, but not showing arm 60 or fastener 64. Base portion 21 is generally cylindrical and has defined therein a vertical, cylindrical closed bore 22. The dimensions of bore 22 may be selected to provide a tight fit on a shaft of a selected diameter of a centrifuge. Base portion 21 is positioned on floor 100 so as to align bore 22 with through hole 106 in floor 100. Base portion 21 also has a horizontal through bore 23 intersecting with vertical bore 22. Pad 25 includes a horizontal through bore aligned with horizontal bore 23. Fastener 24, which may be a set screw, by way of example, is positioned through pad 25 and horizontal through bore 23. Horizontal through bore 23 may be threaded so that fastener 24 mates therewith. Fastener 24 may be advanced into vertical bore 22, as illustrated in FIG. 3, so as to provide a secure fit between mount 20 and the shaft of a centrifuge (not shown). When the rotor 10 is to be removed from the mount, fastener 24 may be withdrawn into horizontal bore 23.

Top portion 26 is generally cylindrical and has a vertical blind bore 27 therein, which may be threaded. Bore 27 may receive fastener 64 shown in FIGS. 1 and 2.

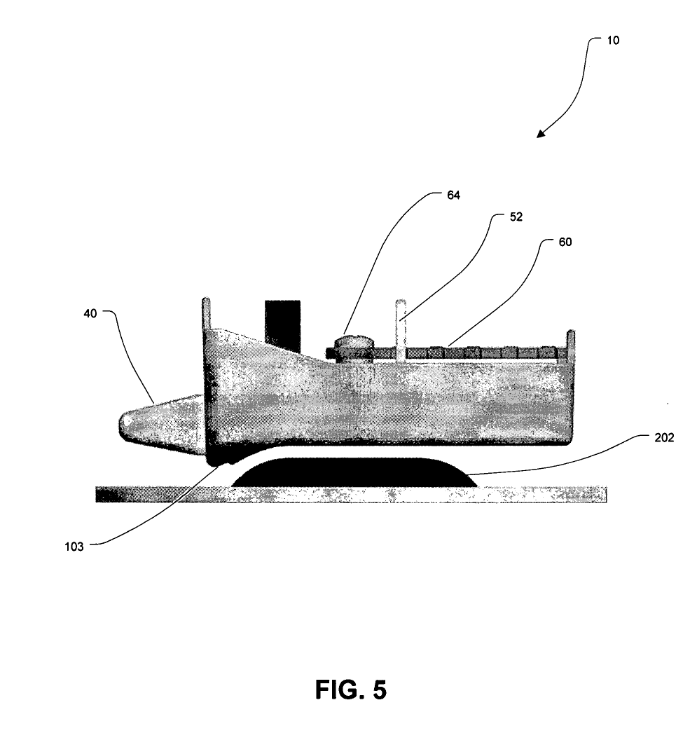

Referring to FIG. 5, a side view of rotor 10 shown positioned slightly above a platform 202 of a centrifuge 200 is shown. The rotor shaft is not shown. Floor 100 is inclined at 103, which incline is also reflected in the interior of chamber 30.

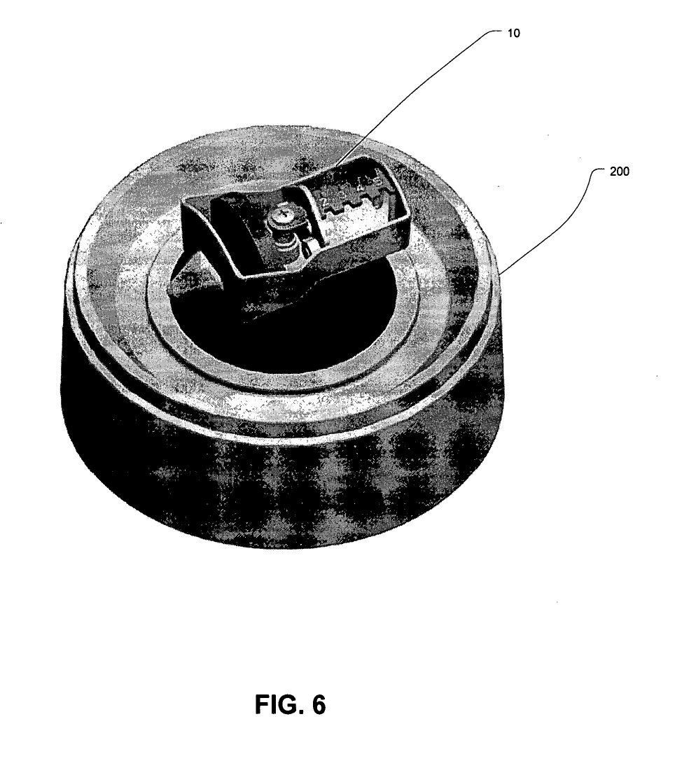

Referring to FIG. 6, a perspective view of rotor 10 is shown in position on centrifuge 200. Centrifuge 200 may be a tabletop centrifuge, by way of example.

In a method of using rotor 10, an object to be centrifuged is placed in chamber 30. A suitable portion of the object, such as an opening, is positioned to face into receptacle 40. The movable counterweight 50 is moved, if needed, to an appropriate position to provide a suitable balance to the object in chamber 30. By way of example, each numbered position may correspond to a difference of about 0.5 to about 1.5 grams in weight of the object. Rotor 10 is placed on a shaft of centrifuge 200, and the set screw may be tightened. The centrifuge is then activated. The centrifuge may be operated at between about 2800 rpm and about 3100 rpm, for example. The centrifuge is stopped, such as by a timer. The object is removed, and receptacle 40 is removed from rotor 10.

By way of non-limiting example, a rotor in accordance with an embodiment of the invention may have a length of about 2.625 inches (excluding receptacle 40), a width of about 1.5 inches at chamber 30, a width of about 1.25 inches at end wall 118, a height at a corner of chamber 30 of about 1.125 inches, and a height at an opposite corner of about 0.875 inches.

Advantages of a device and method in accordance with the invention include providing a rotor which may readily be adjusted to accommodate a variety of weights of objects to be centrifuged. A further advantage is that molding of plastic parts is relatively simple. A further advantage is that weights to be balanced can be adjusted by selection of nuts 53, 55, without changing of any molded parts.

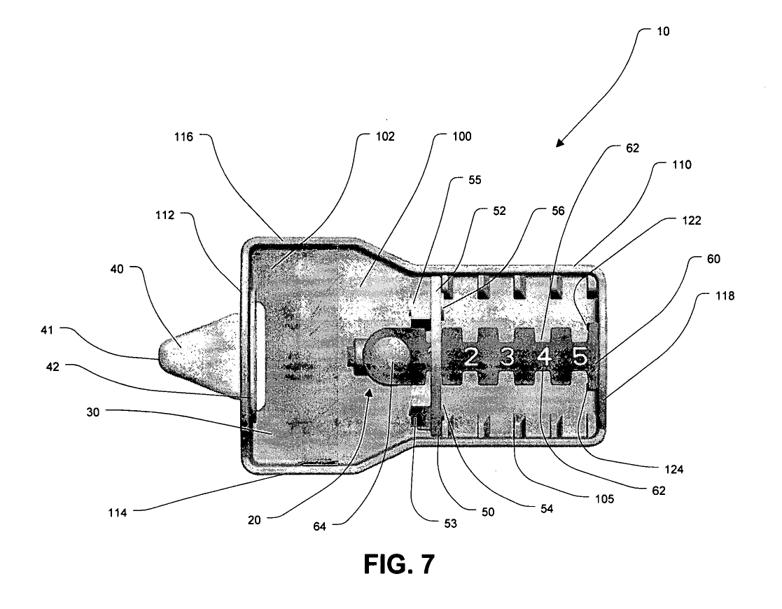

The foregoing description of the embodiments of this invention has been presented for purposes of illustration and description. It is not intended to be exhaustive or to limit the invention to the forms explicitly disclosed, as many modifications and variations are possible without departing from the scope and spirit of the present invention. By way of example, variations in materials may be made. Non-limiting examples of modifications include eliminating foam piece 117, as illustrated in FIG. 7, for example, and varying the number of positions of counterweight 50. It will also be appreciated that features, components, processes and process steps from various embodiments disclosed above may be incorporated in others of the embodiments disclosed above.

What is claimed is:

1. A rotor for a centrifuge, comprising:
a mount;
a chamber to one side of the mount;
a receptacle disposed outward from and in communication with the chamber; and
a movable counterweight to an opposite side of the mount.

2. The rotor of claim 1, wherein said chamber comprises at least a generally vertical end wall portion and a generally horizontal floor portion, said end wall portion having an opening defined therein, said receptacle being in communication with the chamber via the opening.

3. The rotor of claim 2, further comprising a foam member parallel to said end wall portion.

4. The rotor of claim 2, wherein said receptacle has an opening at an inner end thereof, said opening having a circumferential lip for retaining said receptacle in said end wall opening.

5. The rotor of claim 4, wherein said receptacle tapers to a point at an outer end thereof.

6. The rotor of claim 2, wherein said floor portion in said chamber is continuous.

7. The rotor of claim 1, further comprising a positioning arm extending from said mount to an end opposite the chamber, the movable counterweight being selectively positionable along said positioning arm.

8. The rotor of claim 1, wherein said positioning arm is generally planar and horizontal, and has a plurality of pairs of opposing notches defined therein.

9. The rotor of claim 8, wherein said movable counterweight comprises a plate having an opening defined therein and therethrough, an upper portion of said opening in said plate being relatively narrow and so positioned that the upper portion of said plate opening fits over said positioning arm at the location of any one of said pairs of notches but not intermediate said notches, and a lower portion of the plate opening being sufficiently wide to permit a full width portion of the positioning arm to pass therethrough.

10. The rotor of claim 9, further comprising upstanding teeth projecting from a floor of the rotor at locations corresponding to the notches.

11. A rotor for a centrifuge, comprising:
a floor portion;
an end wall at a first end of the rotor and extending upward from the floor portion, the end wall having an opening defined therein;
a receptacle having a continuous receptacle wall and an opening defined in the receptacle wall and coupled to the opening in the end wall; and
a movable counterweight opposite from said end wall.

12. The rotor of claim 11, further comprising a positioning arm extending from said mount to an end opposite the chamber, the movable counterweight being selectively positionable along said positioning arm.

13. The rotor of claim 12, wherein said positioning arm is generally planar and horizontal, and has a plurality of pairs of opposing notches defined therein.

14. The rotor of claim 13, wherein said movable counterweight comprises a plate having an opening defined therein and therethrough, an upper portion of said opening in said plate being relatively narrow and so positioned that the upper portion of said plate opening fits over said positioning arm at the location of any one of said pairs of notches but not intermediate said notches, and a lower portion of the plate opening being sufficiently wide to permit a full width portion of the positioning arm to pass therethrough.

15. The rotor of claim 14, further comprising upstanding teeth projecting from a floor of the rotor at locations corresponding to the notches.

16. A method of centrifuging an object having an opening, comprising the steps of:
placing the object on a floor portion of a chamber of a rotor with the opening of the object oriented toward a receptacle in communication with the chamber;
positioning a movable counterweight located to an opposite side of a mount from the chamber so as to provide a balance to the object; placing the rotor on a shaft of a centrifuge;
activating the centrifuge;
stopping the centrifuge, and removing the object.

17. The method of claim 16, wherein the centrifuge is operated at between about 2800 rpm and about 3100 rpm.

18. The method of claim 16, further comprising the step of removing the receptacle.

19. The method of claim 16, wherein the object is a hearing aid.

20. The method of claim 16, wherein said step of positioning a movable counterweight comprises positioning said counterweight with respect to a positioning arm extending from said mount to an end of the rotor opposite the chamber.
